(19) United States
(12) Patent Application Publication
(10) Pub. No.: US 2024/0234865 A1
(43) Pub. Date: Jul. 11, 2024

(54) DUCT STRUCTURE

(71) Applicant: HONDA MOTOR CO., LTD., Tokyo (JP)

(72) Inventor: Daigo KOMATSU, Tokyo (JP)

(73) Assignee: HONDA MOTOR CO., LTD., Tokyo (JP)

(21) Appl. No.: 18/405,443

(22) Filed: Jan. 5, 2024

(30) Foreign Application Priority Data
Jan. 6, 2023 (JP) 2023-000836

(51) Int. Cl. H01M 10/6566; F16L 9/21; H01M 10/613; H01M 10/625; H01M 10/6563

(52) U.S. Cl. CPC H01M 10/6566; F16L 9/21; H01M 10/613; H01M 10/625; H01M 10/6563; B60L 50/60; H01M 2220/20

(57) ABSTRACT

A duct structure provided inside a battery pack mounted on a vehicle and connecting an intake port of the battery pack to a fan that blows cooling air to a battery, the duct structure includes: a duct member made of nonwoven fabric, wherein the duct member includes a flow path disposed above the fan and extending in a horizontal direction, and among wall portions defining the flow path extending in the horizontal direction, a first wall portion extending in a vertical direction has a thickness smaller than a thickness of a second wall portion extending in the horizontal direction.

### CROSS-REFERENCE RELATED APPLICATIONS

This application is based on and claims priority under 35 USC 119 from Japanese Patent Application No. 2023-000836 filed on Jan. 6, 2023, the contents of which are incorporated herein by reference.

### TECHNICAL FIELD

The present invention relates to a duct structure including a duct member made of nonwoven fabric.

### BACKGROUND ART

In recent years, researches and developments have been conducted on a secondary battery (also referred to as a battery) that contributes to improvement in energy efficiency in order to allow more users to access affordable, reliable, sustainable, and advanced energy.

With electrification of a drive source of a vehicle, the vehicle is equipped with a battery that supplies power to a motor and the like. Since the battery generates heat when supplying power or being charged, the battery needs to be cooled. For example, JP2011-99367A describes a configuration in which cooling air is blown to a battery mounted on an automobile to cool the battery.

JP2011-99367A also describes a ventilation duct connected to a battery case and a blower fan for blowing the cooling air to the battery. The ventilation duct in JP2011-99367A is a member integrated by combining a pair of half-split bodies made of nonwoven fabric shaped by pressing.

### SUMMARY

Nonwoven fabric has excellent sound absorption performance, and by forming a ventilation duct with nonwoven fabric as in JP2011-99367A, absorption of drive noise of a fan or the like can be expected.

On the other hand, nonwoven fabric has lower rigidity than resin, metal, and the like. Regarding duct members made of nonwoven fabric, there is room for improvement from the viewpoint of rigidity.

The present invention provides a duct structure that can improve rigidity of a duct member made of nonwoven fabric. By extension, it contributes to improvement in energy efficiency.

According to the present invention, rigidity of a duct member made of nonwoven fabric can be improved.

### BRIEF DESCRIPTION OF DRAWINGS

FIG. 1 is a perspective view of a battery pack 1 equipped with an intake duct 13, which is an embodiment of a duct structure of the present invention;

FIG. 2 is an exploded perspective view of the battery pack 1;

FIG. 3 is a perspective view of an intake duct 13 connected to a fan 12;

FIG. 4 is a perspective view of a downstream duct member 40;

FIG. 5 is a cross-sectional view taken along a line A-A in FIG. 4, showing a part of a cross section of a horizontal flow path 410;

FIG. 6 is a graph showing a relation between thickness and compression and tensile rigidity of a member made of nonwoven fabric;

FIG. 7 is a graph showing a relation between thickness and bending rigidity of a member made of nonwoven fabric; and

FIG. 8 is a schematic view of a fixing portion 13a provided with a portion B in FIG. 4, as viewed from a horizontal direction.

### DESCRIPTION OF EMBODIMENTS

Hereinafter, one embodiment of a duct structure of the present invention will be described based on the accompanying drawings. Note that the drawings are viewed in directions of reference numerals. In the present description and the like, in order to simplify and clarify the description, a front-rear direction, a left-right direction, and an upper-lower direction are described according to directions viewed from a driver of a vehicle. In the drawings, a front side of the vehicle is shown as Fr, a rear side is shown as Rr, a left side is shown as L, a right side is shown as R, an upper side is shown as U, and a lower side is shown as D.

### Battery Pack

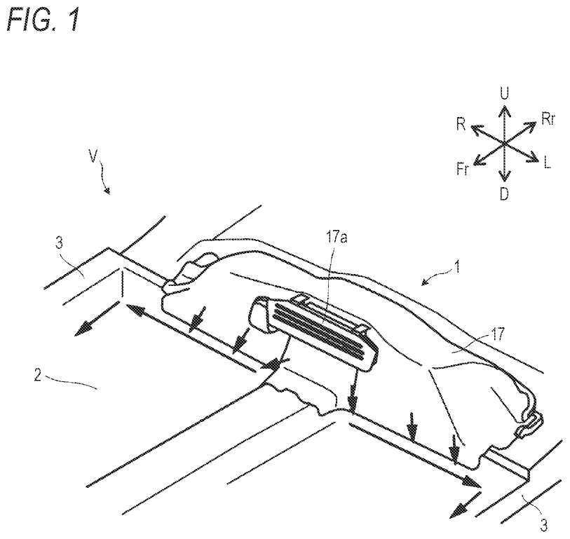

First, a battery pack 1 equipped with an intake duct 13, which is an embodiment of the duct structure of the present invention, will be described. As shown in FIG. 1, the battery pack 1 is mounted on a vehicle V. The vehicle V is an electric vehicle such as a hybrid vehicle or an electric automobile, and is able to travel by driving a motor using electric power stored in the battery pack 1. The battery pack 1 is placed on a floor panel 2 and fixed to the floor panel 2 between a pair of left and right skeleton frame members 3 extending along the front-rear direction. The floor panel 2 constitutes floors of a vehicle interior and a luggage compartment, and a rear seat (not shown) is disposed above the battery pack 1.

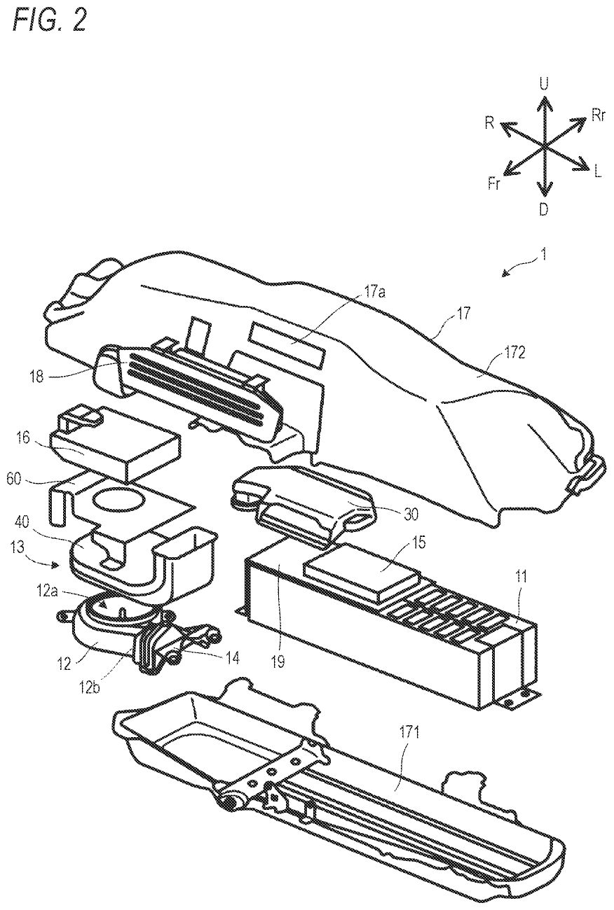

As shown in FIG. 2, the battery pack 1 includes a battery module 11, a fan 12, an intake duct 13, a blower duct 14, and a battery electronic control unit (ECU) 15, a junction board 16, and a battery case 17 that accommodates these members.

The battery case 17 includes a base plate 171 and a cover 172 that covers the base plate 171 from above. The battery module 11, the fan 12, and the blower duct 14 are placed on the base plate 171. The cover 172 covers the base plate 171 and is fixed to the floor panel 2. An intake port 17a is formed on a front surface of the cover 172, and the intake port 17a is covered with a ventilated grille 18.

The battery module 11 has a substantially rectangular parallelepiped shape that is long in a vehicle width direction, and is fixed to the base plate 171. The battery module 11 includes a plurality of battery cells stacked in the vehicle width direction. An inter-cell flow path (not shown) is formed between adjacent battery cells, and the battery module 11 is cooled by cooling air sent out from the blower duct 14 flowing through the inter-cell flow path.

The fan 12 is fixed to base plate 171. The fan 12 is, for example, a sirocco fan. The fan 12 sucks the cooling air through a suction port 12a provided in a rotation axis direction (upper-lower direction in the present embodiment), and blows out the cooling air from a blow-out port 12b provided in a centrifugal direction to the blower duct 14.

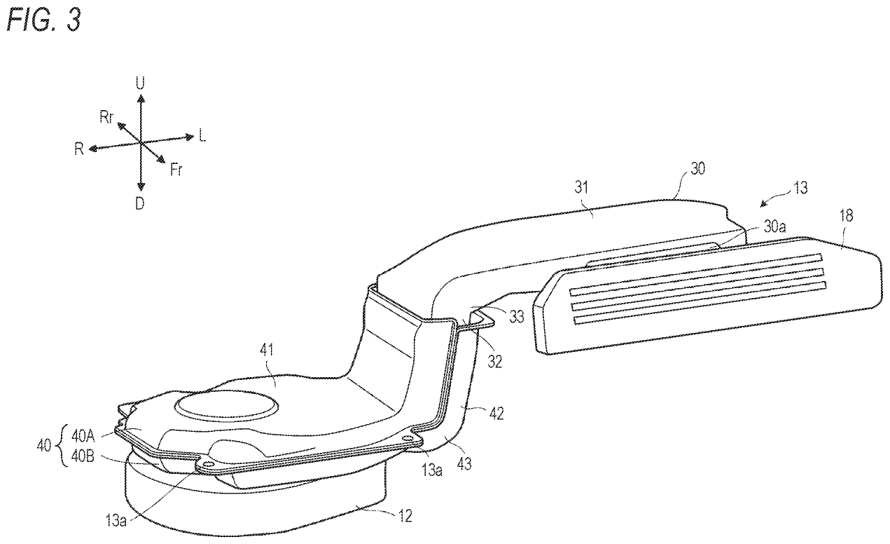

The intake duct 13 connects an intake port 17a provided on the cover 172 and the suction port 12a of the fan 12, as shown in FIGS. 2 and 3. The intake duct 13 guides air in the vehicle interior as the cooling air from the intake port 17a to the fan 12.

The intake duct 13 includes an upstream duct member 30 and a downstream duct member 40. The upstream duct member 30 is connected to the intake port 17a and is disposed above the battery module 11. The downstream duct member 40 is connected to the suction port 12a of the fan 12 and is disposed on the right side of the battery module 11. Details of the intake duct 13 will be described later.

The blower duct 14 is provided between the battery module 11 and the fan 12, and is connected to the blow-out port 12b of the fan 12. The blower duct 14 sends out the cooling air blown out from the blow-out port 12b along a lower surface of the battery module 11. The cooling air sent out below the battery module 11 flows through the inter-cell flow path from the lower side to the upper side so as to cool the battery module 11, and is discharged from an upper surface of the battery module 11. Thereafter, the cooling air flows inside the battery case 17 and is discharged to the outside of the battery case 17 as indicated by the arrows in FIG. 1.

The battery ECU 15 controls charging and discharging of the battery module 11. The battery ECU 15 is mounted on a bracket 19 attached to the battery module 11 and is disposed between the upstream duct member 30 and the battery module 11. The battery ECU 15 includes a processor, a memory, an interface, and the like.

The junction board 16 electrically connects the battery module 11 and external equipment (not shown), and includes wiring components through which charging power and discharging power of the battery module 11 flow. The junction board 16 is disposed above the downstream duct member 40 and on the right side of the upstream duct member 30. The junction board 16 is mounted on a bracket 60 provided above the downstream duct member 40.

### Intake Duct

Next, details of the intake duct 13 will be described with reference to FIGS. 3 to 8.

The intake duct 13 is provided inside the battery pack 1 mounted on the vehicle V, as described above. The intake duct 13 connects the intake port 17a and the fan 12 of the battery pack 1.

As shown in FIG. 3, the intake duct 13 includes the upstream duct member 30 and the downstream duct member 40. The upstream duct member 30 and the downstream duct member 40 are connected to each other by inserting an end portion of the upstream duct member 30 into an end portion of the downstream duct member 40 from above.

The upstream duct member 30 is a substantially L-shaped duct when viewed from the front side. The upstream duct member 30 is made of resin, for example. The upstream duct member 30 is provided with an intake port connection portion 30a which opens forward, and the intake port connection portion 30a is connected to the intake port 17a from the inside of the cover 172.

The upstream duct member 30 includes a horizontal portion 31, a vertical portion 32, and a bent portion 33. The horizontal portion 31 extends in a horizontal direction along the upper surface of the battery module 11. The vertical portion 32 extends in a vertical direction along a right surface of battery module 11. A lower end of the vertical portion 32 is opened downward and connected to the downstream duct member 40. The bent portion 33 connects the horizontal portion 31 and the vertical portion 32. The bent portion 33 changes a traveling direction of the cooling air flowing in the horizontal portion 31 from the horizontal direction to the vertical direction, and guides the cooling air to the vertical portion 32.

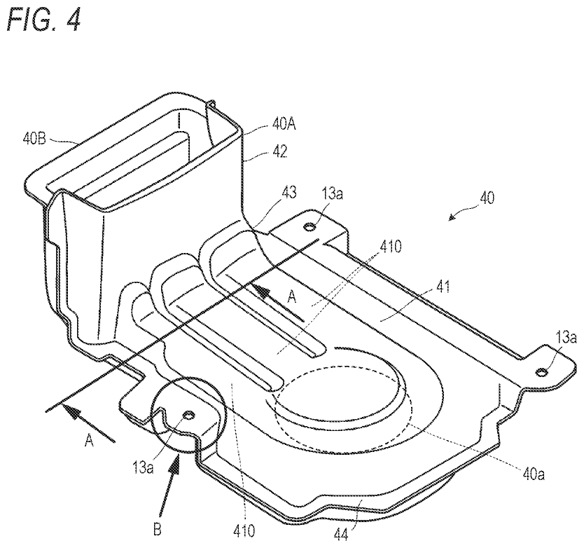

The downstream duct member 40 is a substantially L-shaped duct when viewed from the front side. The downstream duct member 40 is provided with a fan connection portion 40a (see FIG. 4) that opens downward, and the fan connection portion 40a is connected to the suction port 12a of the fan 12 from above.

The downstream duct member 40 is constituted by an upper member 40A and a lower member 40B. The lower member 40B includes the fan connection portion 40a described above and is connected to the fan 12. The upper member 40A is attached to the lower member 40B from above. The upper member 40A and the lower member 40B are in contact with each other at outer edge portions thereof extending in the horizontal direction, are bonded with an adhesive or the like, and define an intake flow path communicating with the fan 12.

As shown in FIGS. 3 and 4, the downstream duct member 40 includes a horizontal portion 41, a vertical portion 42, and a bent portion 43. The horizontal portion 41 extends in the horizontal direction above the fan 12. The vertical portion 42 extends in the vertical direction along the right surface of the battery module 11. An upper end of the vertical portion 42 is opened upward and is connected to the upstream duct member 30. The bent portion 43 connects the horizontal portion 41 and the vertical portion 42. The bent portion 43 changes the traveling direction of the cooling air flowing in the vertical portion 42 from the vertical direction to the horizontal direction, and guides the cooling air to the horizontal portion 41.

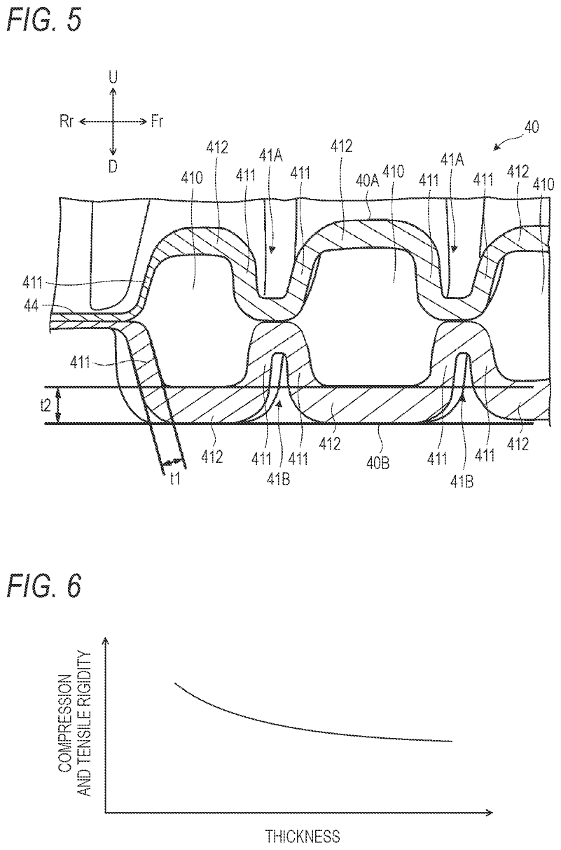

Here, among flow paths formed inside the downstream duct member 40, a horizontal flow path 410 formed inside the horizontal portion 41 will be described using FIG. 5. FIG. 5 is a cross-sectional view taken along a line A-A in FIG. 4.

The horizontal flow path 410 extends in the horizontal direction above the fan 12. The horizontal flow path 410 is defined by an erected wall portion 411 extending in the vertical direction and a horizontal wall portion 412 extending in the horizontal direction. The horizontal wall portion 412 is connected to upper and lower ends of the erected wall portion 411 and extends in the horizontal direction.

The horizontal flow path 410 is divided into a plurality of flow paths in a direction perpendicular to the flow direction (in the present embodiment, the front-rear direction). In the present embodiment, the horizontal flow path 410 is divided into three, and each horizontal flow path 410 is also defined by the erected wall portion 411 and the horizontal wall portion 412. In other words, the erected wall portion 411 is provided between the adjacent horizontal flow paths 410, and rigidity of the downstream duct member 40 is improved against loads input from the vertical direction. The three horizontal flow paths 410 extend in the left-right direction and merge near the fan connection portion 40a.

The erected wall portion 411 that defines each horizontal flow path 410 will be described in detail. The upper member 40A is provided with two upper recesses 41A that are recessed toward the lower member 40B, and the lower member 40B is provided with two lower recesses 41B that are recessed toward the upper member 40A and are in contact with the upper recesses 41A. The upper recesses 41A and the lower recesses 41B include the erected wall portion 411 that defines each horizontal flow path 410. Note that the number of the upper recesses 41A and the number of the lower recesses 41B are determined according to the number of the divided horizontal flow paths 410. For example, when the horizontal flow path 410 is divided into two, the number of the upper recess 41A and the number of the lower recess 41B are each one.

The downstream duct member 40 is made of nonwoven fabric. Specifically, the upper member 40A and the lower member 40B are formed by pressing a sheet-like nonwoven fabric, and the upper member 40A and the lower member 40B are bonded to form the downstream duct member 40. The nonwoven fabric has excellent sound absorption performance, and absorbs acoustic energy of drive noise generated when the fan 12 is driven and fluid noise generated when the cooling air flows. By forming the downstream duct member 40 communicating with the fan 12 from a nonwoven fabric, the drive noise of the fan 12 can be absorbed, and the drive noise traveling through the intake duct 13 and leaking from the intake port 17a into the vehicle interior can be reduced.

On the other hand, the nonwoven fabric has lower rigidity than resin, metal, and the like, and is easily deformed. In the present embodiment, the downstream duct member 40 is disposed between the junction board 16 and the base plate 171 in the vertical direction. When a load in the vertical direction is input from the junction board 16 and the base plate 171 to the downstream duct member 40, the downstream duct member 40 can be deformed. Therefore, it is preferable that the downstream duct member 40 has a configuration that is difficult to deform with respect to a load input from the vertical direction, that is, a configuration that has high rigidity.

FIG. 6 is a graph showing a relation between thickness and compression and tensile rigidity of a member made of nonwoven fabric (hereinafter also referred to as a nonwoven fabric member). Here, the thickness of the nonwoven fabric member changes as the nonwoven fabric member is compressed by pressing or the like. When the thickness of the nonwoven fabric member is small, the nonwoven fabric member is compressed and has a high density, and the compression and tensile rigidity takes a high value. On the other hand, when the thickness of the nonwoven fabric member is large, the nonwoven fabric member is not compressed (or slightly compressed) and has a low density, and the compression and tensile rigidity takes a low value.

FIG. 7 is a graph showing a relation between thickness and bending rigidity of the nonwoven fabric member. When the thickness of the nonwoven fabric member is small, the bending rigidity of the nonwoven fabric member is low, but as the thickness increases, the bending rigidity of the nonwoven fabric member increases.

Returning to FIG. 5, in the present embodiment, among the wall portions defining the horizontal flow path 410, a thickness t1 of the erected wall portion 411 extending in the vertical direction is smaller than a thickness t2 of the horizontal wall portion 412 extending in the horizontal direction. Note that in FIG. 5, a thickness of the rearmost erected wall portion 411 of the lower member 40B is denoted by t1, and a thickness of the horizontal wall portion 412 of the lower member 40B is denoted by t2, but similarly, when a thickness of another erected wall portion 411 that defines each horizontal flow path 410 is denoted by t1, and a thickness of the horizontal wall portion 412 of the upper member 40A is denoted by t2, the thickness t1 of the erected wall portion 411 is smaller than the thickness t2 of the horizontal wall portion 412. For example, the thickness t2 of the horizontal wall portion 412 is approximately 2 to 4 times the thickness t1 of the erected wall portion 411.

Specifically, when molding the downstream duct member 40 from nonwoven fabric, pressing or the like is performed such that a compression ratio is locally increased in a portion corresponding to the erected wall portion 411. Since the thickness t1 of the erected wall portion 411 is smaller than the thickness t2 of the horizontal wall portion 412, the compression and tensile rigidity of the erected wall portion 411 is higher than that of the horizontal wall portion 412. Therefore, the erected wall portion 411 is less likely to be compressed even when a load is input from the vertical direction, and the intake duct 13 is less likely to collapse.

Conversely, since the thickness t2 of the horizontal wall portion 412 is greater than the thickness t1 of the erected wall portion 411, the bending rigidity of the horizontal wall portion 412 is higher than that of the erected wall portion 411. Therefore, the horizontal wall portion 412 becomes difficult to bend even when a load is input from the vertical direction, and the intake duct 13 becomes difficult to bend.

As described above, during molding, the portion of the nonwoven fabric material corresponding to the erected wall portion 411 is compressed to reduce the thickness, so that in the downstream duct member 40, the density of the nonwoven fabric in the erected wall portion 411 is higher than the density of the nonwoven fabric in the horizontal wall portion 412. In this way, by increasing the density of the nonwoven fabric in the erected wall portion 411 through compression, the thickness of the erected wall portion 411 can be made smaller than the thickness of the horizontal wall portion 412.

Returning to FIGS. 3 and 4, three fixing portions 13a are provided on a contact portion 44 at outer edge portions of the upper member 40A and the lower member 40B of the downstream duct member 40. Each of the fixing portions 13a has an insertion hole through which a fastening means such as a pin-shaped clip (not shown) can be inserted, for example. The downstream duct member 40 is fixed to the base plate 171 by inserting a clip into the fixing portions 13a and a fixing portion (not shown) provided on the base plate 171. Note that the fastening means may be bolts or the like. Fixing of the downstream duct member 40 to the base plate 171 is not limited to these methods, and any fixing method can be adopted.

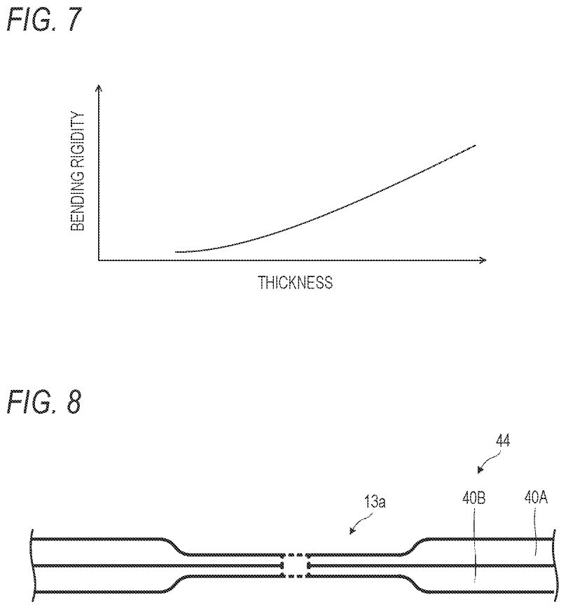

FIG. 8 is a schematic view of the fixing portion 13a provided with a portion B in FIG. 4, as viewed from the horizontal direction. As shown in FIG. 8, the thickness of the fixing portion 13a is smaller than the thickness of the contact portion 44 excluding the fixing portion 13a. In the contact portion 44 between the upper member 40A and the lower member 40B, since the thickness of the fixing portion 13a is locally reduced, the downstream duct member 40 can be easily fixed to the base plate 171 using a clip or the like. Since the contact portion 44 excluding the fixing portion 13a has a large thickness, the bending rigidity of the contact portion 44 is high, and it is possible to make a structure that is difficult to bend against a load input from the vertical direction.

Since the horizontal wall portion 412 of the downstream duct member 40 is formed to have a large thickness, the sound absorption performance of the horizontal wall portion 412 is high. Especially, since the drive noise of the fan 12 first travels upward from below the downstream duct member 40, by increasing the thickness of the horizontal wall portion 412 of the upper member 40A of the downstream duct member 40, the sound absorption performance of the downstream duct member 40 can be improved.

As described above, according to the downstream duct member 40 of the present embodiment, the sound absorption performance can be improved, and it is possible to make a structure that is highly rigid against loads input from the outside.

Although an embodiment of the present invention has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, respective constituent elements in the above embodiment may be freely combined without departing from the gist of the invention.

For example, in the embodiment described above, the horizontal flow path 410 is divided into a plurality of flow paths, but the horizontal flow path 410 may not be divided. That is, it is not necessary to provide the upper recess 41A and the lower recess 41B.

In the present description, at least the following matters are described. In the parentheses, the corresponding constituent elements and the like in the embodiment described above are shown as an example, but the invention is not limited thereto.

(1) A duct structure (intake duct 13) provided inside a battery pack (battery pack 1) mounted on a vehicle (vehicle V) and connecting an intake port (intake port 17a) of the battery pack to a fan (fan 12) that blows cooling air to a battery (battery module 11), the duct structure including:
a duct member (downstream duct member 40) made of nonwoven fabric, in which
the duct member includes a flow path (horizontal flow path 410) disposed above the fan and extending in a horizontal direction, and
among wall portions defining the flow path extending in the horizontal direction, a first wall portion (erected wall portion 411) extending in a vertical direction has a thickness smaller than a thickness of a second wall portion (horizontal wall portion 412) extending in the horizontal direction.

The compression and tensile rigidity of a member made of nonwoven fabric increases as the thickness thereof decreases, and the bending rigidity decreases as the thickness increases. According to (1), since the thickness of the first wall portion extending in the vertical direction is smaller than the thickness of the second wall portion extending in the horizontal direction, the compression and tensile rigidity of the first wall portion becomes high, and it is possible to make a duct structure that is difficult to be compressed by a load input from the vertical direction. Furthermore, since the thickness of the second wall portion is greater than the thickness of the first wall portion, the bending rigidity of the second wall portion is high, and it is possible to make a duct structure that is difficult to bend against a load input from the vertical direction.

(2) The duct structure according to (1), in which
in the duct member, a density of the nonwoven fabric in the first wall portion is higher than a density of the nonwoven fabric in the second wall portion.

According to (2), by making the density of the nonwoven fabric in the first wall portion higher than the density of the second wall portion by compression, the thickness of the first wall portion can be made smaller than the thickness of the second wall portion.

(3) The duct structure according to (1) or (2), in which
the duct member includes an upper member (upper member 40A) and a lower member (lower member 40B),
outer edge portions of the upper member and the lower member come into contact with each other, and the flow path is defined between the upper member and the lower member,
a contact portion (contact portion 44) between the upper member and the lower member includes a fixing portion (fixing portion 13a) fixed to another member (base plate 171) by a fastening means, and
a thickness of the fixing portion is smaller than a thickness of the contact portion excluding the fixing portion.

According to (3), since the fixing portion has a thickness smaller than those of other portions, it is easy to fix the fixing portion by the fastening means. On the other hand, since the thickness of the contact portion excluding the fixing portion is greater than the thickness of the fixing portion, the bending rigidity of the contact portion is high, and it is possible to make a structure that is difficult to bend against a load input from the vertical direction.

(4) The duct structure according to (1) or (2), in which
the flow path is divided into a plurality of flow paths in a direction perpendicular to a flow direction, and
among wall portions defining each of the plurality of flow paths, the first wall portion extending in the vertical direction has a thickness smaller than a thickness of the second wall portion extending in the horizontal direction.

According to (4), since the flow path is divided into a plurality of flow paths, a plurality of first wall portions are also provided to define each of the flow paths. By making the thickness of each first wall portion smaller than that of the second wall portion, the compression and tensile rigidity of each first wall portion can be increased, and it is possible to make a duct structure that is difficult to be compressed by a load input from the vertical direction.

(5) The duct structure according to (4), in which
the duct member includes an upper member (upper member 40A) and a lower member (lower member 40B),
outer edge portions of the upper member and the lower member come into contact with each other, and each of the plurality of flow paths is defined between the upper member and the lower member,
the upper member is provided with at least one upper recess (upper recess 41A) that is recessed toward the lower member,
the lower member is provided with at least one lower recess (lower recess 41B) that is recessed toward the upper member and comes into contact with the upper recess, and
the upper recess and the lower recess include the first wall portion that defines each of the plurality of flow paths.

According to (5), each flow path of the duct member can be formed by bringing the upper recess and the lower recess provided in the upper member and the lower member, respectively, into contact with each other. Since the upper recess and the lower recess include the first wall portion that has a thickness smaller than that of the second wall portion that extends in the horizontal direction, it is possible to make a duct structure that is difficult to be compressed by a load input from the vertical direction.

What is claimed is:

1. A duct structure provided inside a battery pack mounted on a vehicle and connecting an intake port of the battery pack to a fan that blows cooling air to a battery, the duct structure comprising:
a duct member made of nonwoven fabric, wherein
the duct member includes a flow path disposed above the fan and extending in a horizontal direction, and
among wall portions defining the flow path extending in the horizontal direction, a first wall portion extending in a vertical direction has a thickness smaller than a thickness of a second wall portion extending in the horizontal direction.

2. The duct structure according to claim 1, wherein
in the duct member, a density of the nonwoven fabric in the first wall portion is higher than a density of the nonwoven fabric in the second wall portion.

3. The duct structure according to claim 1, wherein
the duct member includes an upper member and a lower member,
outer edge portions of the upper member and the lower member come into contact with each other, and the flow path is defined between the upper member and the lower member,
a contact portion between the upper member and the lower member includes a fixing portion fixed to another member by a fastening means, and
a thickness of the fixing portion is smaller than a thickness of the contact portion excluding the fixing portion.

4. The duct structure according to claim 1, wherein
the flow path is divided into a plurality of flow paths in a direction perpendicular to a flow direction, and
among wall portions defining each of the plurality of flow paths, the first wall portion extending in the vertical direction has a thickness smaller than a thickness of the second wall portion extending in the horizontal direction.

5. The duct structure according to claim 4, wherein
the duct member includes an upper member and a lower member,
outer edge portions of the upper member and the lower member come into contact with each other, and each of the plurality of flow paths is defined between the upper member and the lower member,
the upper member is provided with at least one upper recess that is recessed toward the lower member,
the lower member is provided with at least one lower recess that is recessed toward the upper member and comes into contact with the upper recess, and
the upper recess and the lower recess include the first wall portion that defines each of the plurality of flow paths.
